(19) United States
(12) Patent Application Publication
(10) Pub. No.: US 2001/0027967 A1
(43) Pub. Date: Oct. 11, 2001

(54) Soldering apparatus and mounted part removing apparatus

(75) Inventor: Akira Noguchi, Gunma (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/817,060

(22) Filed: Mar. 27, 2001

(30) Foreign Application Priority Data
Mar. 27, 2000 (JP) 2000-087381

(51) Int. Cl. B23K 3/00

(52) U.S. Cl. 219/209; 392/382; 392/379; 228/232; 219/476

(57) ABSTRACT

A soldering apparatus is provided with a holding section for mounting and holding a board to which reflow solder is previously applied and in which a mounted part is mounted on the reflow solder, a moving section for automatically moving a holding part between a heating position and a board mounted position, a first heater for heating a face having no mounted part of the board at a temperature lower than a solder melting point and a second heater for heating a connection range of the board and the mounted part at a temperature higher than the solder melting point. The soldering apparatus also has a timer for setting a heating time of the first heater and the second heater.

### BACKGROUND OF THE INVENTION

1. Field of the Invention

The present invention relates to a soldering apparatus and a mounted part removing apparatus and more particularly to the soldering apparatus suitable for a case in that mounted parts are soldered after applying reflow soldering to a printed-wiring board or a like.

The present application claims priority of Japanese Patent Application No. 2000-087381 filed on Mar. 27, 2000, which is hereby incorporated by reference.

2. Description of Related Art

As a method of soldering mounted parts on a printed-wiring board, a technique is known in that mounted parts are soldered after applying reflow soldering to the printed-wiring board. Conventionally, soldering is executed by melting solder using a soldering iron by a manual operation.

However, in the conventional soldering method by the manual operation, there is a problem in that working efficiency is not good when small parts are soldered. Flux scatter occurs, and there is another problem in that a harmful influence occurs on a performance of an electronic apparatus. Further, there is still another problem in that a work quality and a work time are influenced by skill of an operator due to the manual operation.

### SUMMARY OF THE INVENTION

In view of the above, it is an object of the present invention to provide a soldering apparatus for providing a high work efficiency regardless of a size of a mounted part and for obtaining a high working efficiency in a constant time without influences of skill of an operator.

According to a first aspect of the present invention, there is provided a soldering apparatus including:

a heater for heating at least a range including a connection range of a mounted part and a board, in the board from a right side and a reverse side, the board to which reflow solder is previously applied and in which the mounted part is mounted on the reflow solder, so that the mounted part is soldered on the board.

In the foregoing, a preferable mode is one further including:

a holding section for mounting and holding the board; and

a moving section for automatically moving the holding section between a heating position and a board mounted position.

Also, a preferable mode is one wherein the heater includes a first heater for heating a side having no mounted part of the board at a temperature lower than a solder melting point and a second heater for heating the connection range of the board and the mounted part at a temperature higher than the solder melting point.

Also, a preferable mode is one wherein the first heater heats all over a range including the connection range of the board and the mounted part and the second heater heats the connection part of the board and the mounted part in spots.

Also, a preferable mode is one further including:

a timer;

wherein the board is heated in accordance with a value set by the timer.

Furthermore, a preferable mode is one wherein the moving section includes an air cylinder and a controller for controlling air to be supplied to the air cylinder, and the timer sets a time to supply air to the air cylinder.

According to a second aspect of the present invention, there is provided a mounted part removing apparatus including:

a holding section for holding a board on which a mounted part is soldered;

a heater for heating the board;

a moving section for moving the holding section between a heating position and a board mounted position; and

a removing section for removing the mounted part from the board at the heating position;

wherein the board is moved to the heating position, the heater heats at least a range including a connection range of the mounted part and the board, and the mounted part is removed from the board.

In the foregoing, a preferable mode is one further including:

a timer;

wherein the board is heated in accordance with a value set by the timer.

With this configuration, since the connection range of the mounted part and the board is heated from both of a right side and a reverse side, heat conductivity is improved and thereby it is possible to solder in a short time.

Also, it is possible to improve soldering operation efficiency.

Also, the board is heated from both of the side on which the mounted part is mounted and the side having no mounted part, and thereby it is possible to solder more efficiently. In this case, since the side having no mounted part is heated at a temperature lower than the solder melting point and the side having the mounted part is heated at a temperature higher than the solder melting point, it is possible to solder without damaging the board.

Also, since the board having the mounted part is pre-heated by the first heater, and then the connection range of the board and the mounted part is main-heated by the second heater, it is possible to solder more effectively.

Also, since time for a solder operation can be set constant using the timer, it is possible to further improve working efficiency.

Further, the soldering apparatus of the present invention can be used as a mounted part removing apparatus. In this case, it is possible to remove the mounted part effectively and accurately similarly to a soldering operation.

Furthermore, since heaters are positioned under and over a printed-wiring board, heat conductivity improves and it is possible to solder parts in a short time. Also, since the timer sets a heating time, it is possible to keep a working time constant and working efficiency improves. Further, since it is possible to solder by a mechanical operation, a quality of soldering becomes stable.

### BRIEF DESCRIPTION OF THE DRAWINGS

The above and other objects, advantages, and features of the present invention will be more apparent from the following description taken in conjunction with the accompanying drawings in which:

FIG. 1 is a view showing a whole configuration of a soldering apparatus according to an embodiment of the present invention;

FIG. 2 is a view showing a state in that a printed-wiring board is set in the soldering apparatus according to the embodiment of the present invention; and

FIG. 3 is a sectional view showing a section indicated by a line A-A in FIG. 2.

### DETAILED DESCRIPTION OF THE PREFERRED EMBODIMENTS

Best modes for carrying out the present invention will be described in further detail using an embodiment with reference to the accompanying drawings.

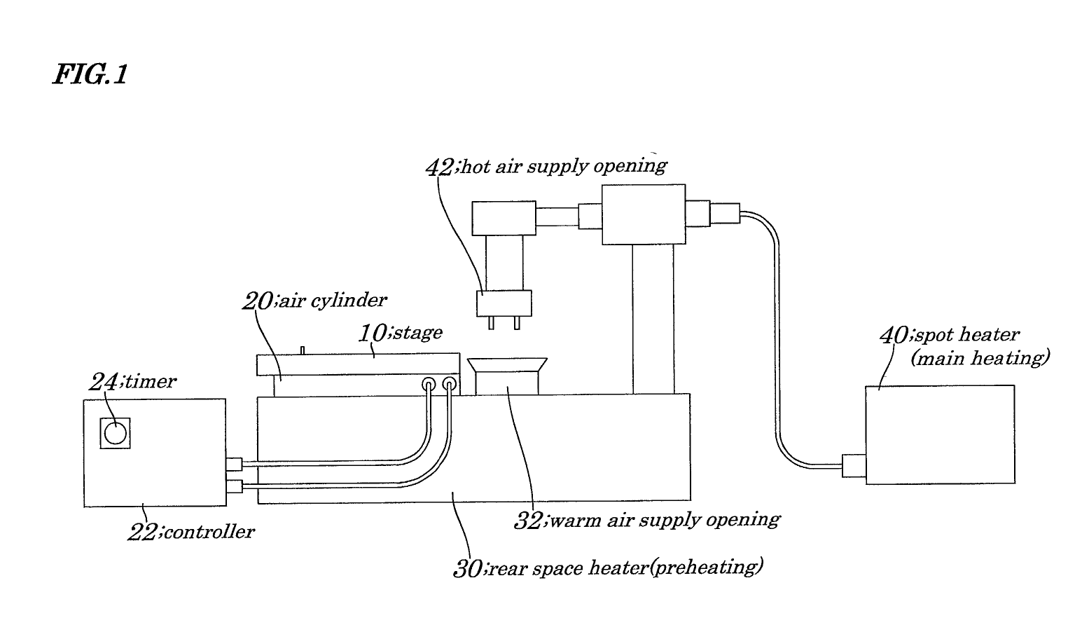

FIG. 1 is a view showing a whole configuration of a soldering apparatus according to the present invention. The soldering apparatus is provided with a stage 10 for holding a printed-wiring board on which mounted parts are soldered, an air cylinder 20 for moving the stage 10 between a mounted position of the printed-wiring board and a soldering position (heating position), a rear space heater 30 for supplying hot air at a temperature lower than a solder melting point to a reverse side of the printed-wiring board and a spot heater 40 for supplying hot air at a temperature higher than the solder melting point to a spot to be soldered on the board-wiring board. The air cylinder 20 is provided with a controller 22 for controlling air supply to the air cylinder 20, and the controller 22 is provided with a timer 24. A warm air supply opening 32 of the rear space heater 30 and a hot air supply opening 42 of the spot heater 40 are positioned so that the printed-wiring board mounted on the stage 10 is put between the warm air supply opening 32 and the hot air supply opening 42 and so that the warm air supply opening 32 and the hot air supply opening 42 are opposite up and down.

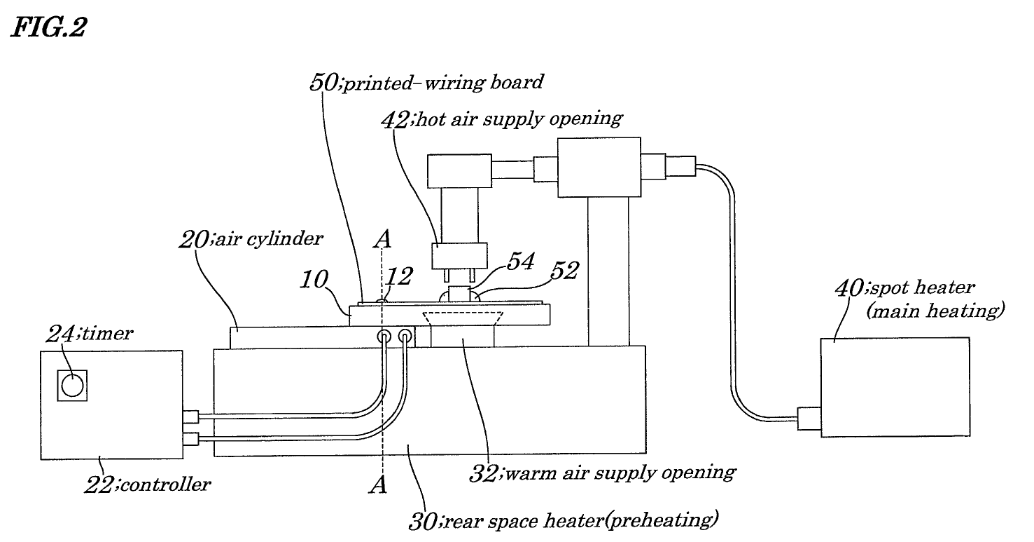

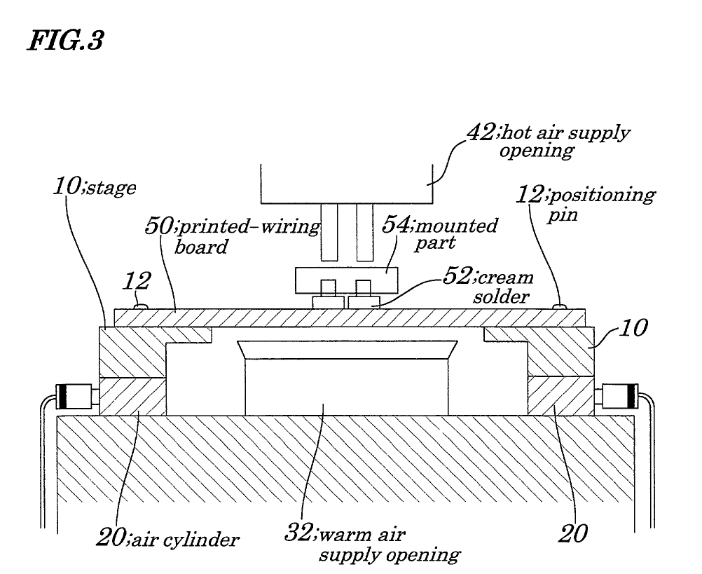

FIG. 2 is a view showing a state in that a printed-wiring board 50 on which parts are mounted is put on the stage 10 and the stage 10 is moved to a heating position and FIG. 3 is a sectional view showing a section indicated by a line A-A in FIG. 2.

Paste solder 52 is painted on the printed-wiring board 50, a mounted part 54 is mounted on the paste solder 52 and then the mounted part 54 is positioned and fixed on the stage 10. Positioning and fixing are executed by engaging a standard hole arranged in a periphery of the printed-wiring board 50 with a positioning pin 12 arranged on the stage 10.

A power switch (not shown) of the rear space heater 30 and a power switch (not shown) of the spot heater 40 are turned ON so that warm air of a constant volume is supplied from the warm air supply opening 32 and hot air of a constant volume is supplied from the hot air supply opening 42 to the heating position. The timer 24 in the controller 22 is set to a solder melting time.

When a switch (not shown) of the controller 22 is turned ON, air is supplied to the air cylinder 20, and then the stage 10 on which the printed-wiring board 50 is mounted is moved to the heating position and is stopped. At the heating position, warm air at a temperature lower than the solder melting point is supplied from the warm air supply opening 32 of the rear space heater 30 to the reverse side of the printed-wiring board 50, and hot air at a temperature higher than the solder melting point is supplied from the hot air supply opening 42 of the spot heater 40 to a right side of the printed-wiring board 50.

Also, the warm air supplied from the warm air supply opening 32 heats all over a constant range including a paint part of the paste solder 52 in the reverse side of the printed-wiring board 50. The hot air supply opening 42 is provided with two long and narrow supply openings and supplies hot air to a connection range of the paint part of the paste solder 52 and the mounted part 54 in spots. With this configuration, the printed-wiring board 50 is pre-heated from the reverse side. The connection range of the paint part of the paste solder 52 and the mounted part 54 are main-heated from the right side.

As described above, when the stage 10 on which the printed-wiring board 50 is mounted moves to the heating position and is stopped, the printed-wring board 50 is heated from both of the reverse side and the right side during the time set by the timer 24. When a temperature achieves a solder melting point, the paste solder 52 is melted and then the mounted part 54 is soldered on the printed-wiring board 50. When it becomes the time set by the timer 24, air supply to the air cylinder 20 is stopped, the stage 10 returns to the board mounted position, and then soldering is finished.

It is thus apparent that the present invention is not limited to the above embodiments but may be changed and modified without departing from the scope and spirit of the invention.

For example, in the embodiment, the timer 24 is provided for the controller 22, however, timers may be provided for controllers (not shown) of the rear space heater 30 and the spot heater 40. In this case, it is not always necessary to set an ON-time of the rear space heater 30 and an ON-time of the spot heater 40 equally, for example, a heating time of the rear space heater 30 may be set longer than a heating time of the spot heater 40, pre-heating may be executed sufficiently, spot heating may be executed, and thereby soldering may be executed.

Also, in the embodiment, the mounted part 54 is soldered on the printed-wiring board 50, however, the soldering apparatus of the present invention may be used to remove soldered parts from the printed-wiring board 50. In this case, the timer 24 is set to a predetermined time, solder fixing the mounted part 54 is heated, and then the mounted part 50 are removed from the printed-wiring board 50 (stage 10) which returns to the board mounted position by hand or a pickup apparatus after a predetermined time.

It is thus apparent that the present invention is not limited to the above embodiments but may be changed and modified without departing from the scope and spirit of the invention.

What is claimed is:

1. A soldering apparatus comprising:
a heater for heating at least a range including a connection range of a mounted part and a board, in said board from a right side and a reverse side, said board to which reflow solder is previously applied and in which said mounted part is mounted on said reflow solder, so that said mounted part is soldered on said board.

2. The soldering apparatus according to claim 1, further comprising:
a holding section for mounting and holding said board; and
a moving section for automatically moving said holding section between a heating position and a board mounted position.

3. The soldering apparatus according to claim 1, wherein said heater comprises a first heater for heating a side having no mounted part of said board at a temperature lower than a solder melting point and a second heater for heating said connection range of said board and said mounted part at a temperature higher than said solder melting point.

4. The soldering apparatus according to claim 3, wherein said first heater heats all over a range including said connection range of said board and said mounted part and said second heater heats said connection part of said board and said mounted part in spots.

5. The soldering apparatus according to claim 1, further comprising:
a timer;
wherein said board is heated in accordance with a value set by said timer.

6. The soldering apparatus according to claim 5, wherein said moving section comprises an air cylinder and a controller for controlling air to be supplied to said air cylinder, and said timer sets a time to supply air to said air cylinder.

7. The soldering apparatus according to claim 2, wherein said heater comprises a first heater for heating a side having no mounted part of said board at a temperature lower than a solder melting point and a second heater for heating said connection range of said board and said mounted part at a temperature higher than said solder melting point.

8. The soldering apparatus according to claim 7, wherein said first heater heats all over a range including said connection range of said board and said mounted part and said second heater heats said connection part of said board and said mounted part in spots.

9. The soldering apparatus according to claim 2, further comprising:
a timer;
wherein said board is heated in accordance with a value set by said timer.

10. The soldering apparatus according to claim 9, wherein said moving section comprises an air cylinder and a controller for controlling air to be supplied to said air cylinder, and said timer sets a time to supply air to said air cylinder.

11. A mounted part removing apparatus comprising:
a holding section for holding a board on which a mounted part is soldered;
a heater for heating said board;
a moving section for moving said holding section between a heating position and a board mounted position; and
a removing section for removing said mounted part from said board at said heating position;
wherein said board is moved to said heating position, said heater heats at least a range including a connection range of said mounted part and said board, and said mounted part is removed from said board.

12. The mounted part removing apparatus according to claim 11, further comprising:
a timer;
wherein said board is heated in accordance with a value set by said timer.
